(19) United States
(12) Patent Application Publication
(10) Pub. No.: US 2025/0363702 A1
(43) Pub. Date: Nov. 27, 2025

(54) COMPOSITE AVATAR

(71) Applicant: Microsoft Technology Licensing, LLC, Redmond, WA (US)

(72) Inventors: Julien Pascal Christophe VALENTIN, Zurich (CH); Charles Thomas HEWITT, Cambridge (GB); Darren Peter COSKER, Dursley (GB); Fang MA, London (GB); James Martin CLEMOES, Cambridge (GB); Ju ZHANG, London (GB); Lohit Dev PETIKAM, Cambridge (GB); Marek Adam KOWALSKI, Komorow (PL); Marta Malgorzata WILCZKOWIAK, Cambridge (GB); Xian XIAO, London (GB); Chidi Aristotle MBADUGHA, Renton, WA (US); Gemma Jen-Man Suen RUSCOE, Wokingham (GB); Stephen Jacob HOOGENDYK, San Clemente, CA (US); Ka Yin LEE, Renton, WA (US); Tadas BALTRUSAITIS, Cambridge (GB); Virginia ESTELLERS CASAS, Zurich (CH); Shideh REZAEIFAR, Zurich (CH); Gregory Bishop BAHM, Kirkland, WA (US)

(73) Assignee: Microsoft Technology Licensing, LLC, Redmond, WA (US)

(21) Appl. No.: 18/670,633

(22) Filed: May 21, 2024

(51) Int. Cl. G06T 13/40; G06T 13/20; G06V 10/70; G06V 40/16; G06V 40/20

(52) U.S. Cl. CPC G06T 13/40; G06T 13/205; G06V 10/70; G06V 40/171; G06V 40/174; G06V 40/20; G06T 2200/24; G06V 2201/12

(57) ABSTRACT

Examples are disclosed that relate to generating an avatar of a user that accurately represents an identity of the user. In one example, a manually-generated avatar including a first head connected to a body is received. Image data of a user is received from a camera. A machine-generated avatar of the user is generated, via an avatar machine-learning model, based at least on the image data. The avatar machine-learning model is trained on training data including a plurality of three-dimensional scans of human heads. The machine-generated avatar of the user comprises a second head having facial features that map to actual facial features of the user. A composite avatar of the user is generated by replacing the first head with the second head on the body of the manually-generated avatar. A graphical user interface including the composite avatar is displayed via a display device.

### BACKGROUND

An avatar refers to a graphical representation of a user in a digital environment, such as in online forums, virtual worlds, or social media platforms. A user can express their identity, personality, and/or current mood through the appearance and expression of an avatar.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to generating a composite avatar of a user that accurately represents an identity of the user. In one example, a manually-generated avatar including at least a first head connected to a body is received. Image data of a user is received from a camera. A machine-generated avatar of the user is generated, via an avatar machine-learning model, based at least on the image data. The machine-learning model is trained on training data including a plurality of three-dimensional scans of human heads. The avatar machine-generated avatar of the user comprises a second head having facial features that map to actual facial features of the user. A composite avatar of the user is generated by replacing the first head of the manually-generated avatar with the second head of the machine-generated avatar on the body of the manually-generated avatar. A graphical user interface including the composite avatar is displayed via a display device.

### BRIEF DESCRIPTION OF THE DRAWINGS

FIG. 1 shows an example scenario in which a user is interacting with avatars representing other remote users in a graphical user interface displayed by a computing system.

FIG. 2 schematically shows an example computing system that is configured to generate a composite avatar of a user.

FIG. 3 schematically shows an example composite avatar generated based at least on a combination of a manually-generated avatar and a machine-generated avatar.

FIG. 4 shows an example process of generating an example composite avatar from a manually-generated avatar and a machine-generated avatar.

FIGS. 5A-5B show an example method of generating a composite avatar.

FIG. 6 shows an example computing system.

### DETAILED DESCRIPTION

As mentioned above, an avatar is a graphical representation of a user in a digital environment, such as in online forums, virtual worlds, or social media platforms. A user can express their identity, personality, and/or current mood through the appearance and expression of an avatar.

Many avatars are manually generated by humans. In some examples, conventional avatars are generated by skilled artists, such as graphic designers or video game designers. In some such examples, the manually-generated avatars created by the skilled artists may be fully formed and presented as a finished product. In other examples, a user may manually generate an avatar to represent themself. For example, a user may be presented with a catalogue of different partially-formed avatars or default avatars that can be customized with various assets (e.g., clothing, hair style, facial hair, glasses, jewelry, hat, textures (e.g., skin textures)), and the user may customize an avatar with assets selected from the catalogue.

However, conventional avatars that are generated by artists/users do not necessarily have visual traits that accurately represent an identity of a user or emote actual expressions of a user that the avatar represents in a computing environment. More particularly, conventional, manually-generated avatars do not have “life-like” head/facial features that accurately match the actual head/facial features of a user. Also, when animated, conventional, manually-generated avatars do not accurately emote expressions that match actual expressions emoted by a user.

Furthermore, it potentially requires a significant amount of manual work and time for human(s) to manually generate conventional avatars. In some cases, multiple artists/users may be involved in the process of manually generating a conventional avatar. This invites the opportunity for errors/imprecisions to propagate/accumulate at every step of the process of manually generating the conventional avatar. Moreover, this means there is potentially a significant amount of time consumed and manual work expended to maintain compatibility and quality of the conventional manually-generated avatar between different artists/users.

Accordingly, examples are disclosed that relate to generating an avatar of a user that accurately represents an identity of the user as well as expressions emoted by the user. In this context, the identity of a user refers to characterizing distinguishing features of a body, head, and/or face of a user that would be used to recognize or identify the user. In one example, a manually-generated avatar including at least a first head connected to a body is received. Image data of a user is received from a camera. A machine-generated avatar of the user is generated, via an avatar machine-learning model, based at least on the image data. The machine-learning model is trained on training data including a plurality of three-dimensional scans of human heads. The avatar machine-generated avatar of the user comprises a second head having facial features that map to actual facial features of the user. A composite avatar of the user is generated by replacing the first head with the second head on the body of the manually-generated avatar. A graphical user interface including the composite avatar is displayed via a display device.

The technical feature of replacing the first head of the manually-generated avatar with the second head of the machine-generated avatar in the composite avatar provides the technical benefit of the composite avatar having facial features that more accurately represent the identity of the user and expressions emoted by user than the manually-generated avatar alone. Moreover, since the second head of the composite avatar is generated by a machine learning model, the time and manual work expended by a human to generate the composite avatar may be less than an equivalent version of the avatar generated solely by humans. Further, in some implementations, the assets created for the first head of the manually-generated avatar can be deformed to fit the second head of the machine-generated avatar, so that the composite avatar can be customized as desired by the user while still preserving accurate identity and emotions of the user.

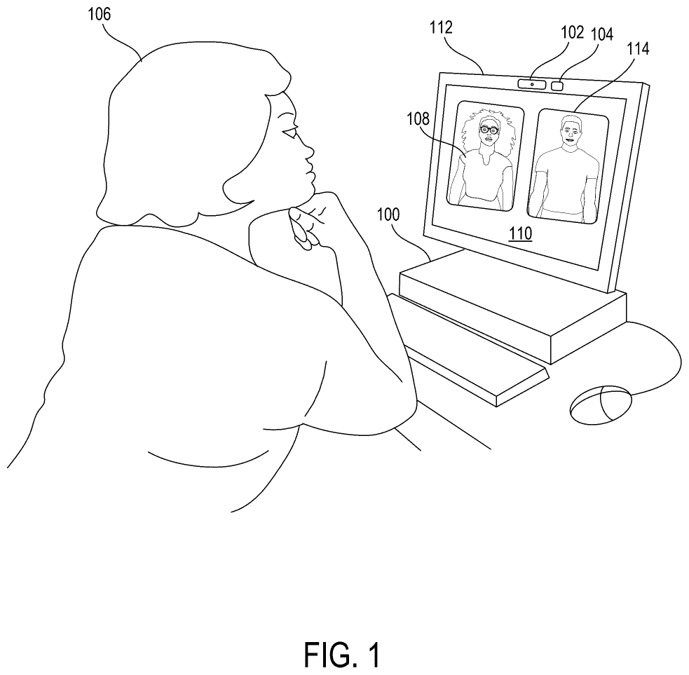

FIG. 1 shows an example scenario in which a user is interacting with another remote user in a digital environment and each user is represented by a composite avatar generated and displayed by a computing system 100 according to the approach described herein.

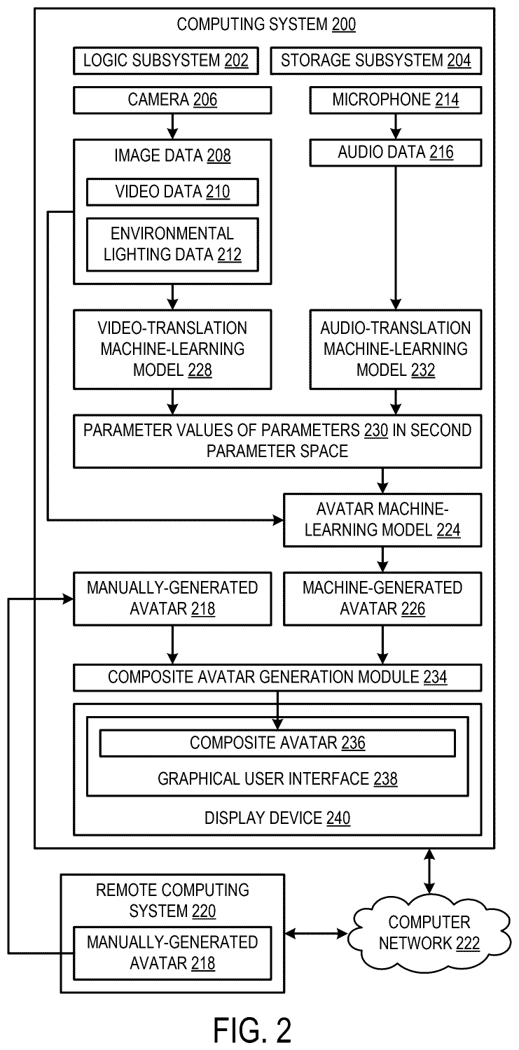

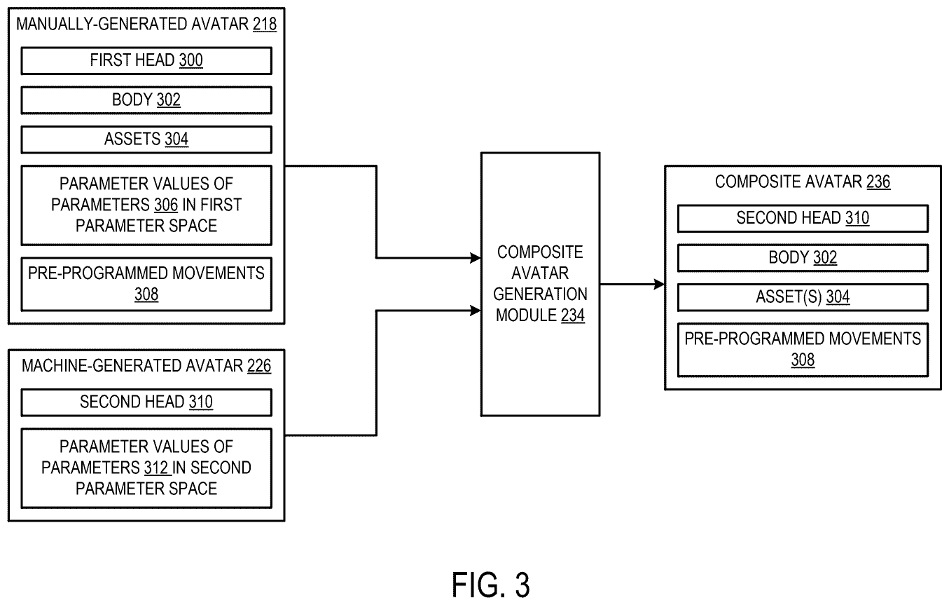

The computing system 100 comprises a webcam-style camera 102 and a microphone 104. The camera 102 is configured to capture image data of a user 106. The microphone 104 is configured to capture audio data representing speech of the user 106. The computing system 100 is configured to receive a manually-generated avatar 218 (shown in FIG. 2). In this example, the manually-generated avatar 218 is generated by a skilled artist or artists (e.g., graphic designers) who design avatars for use in a video chat application program executed by the computing system 100. For example, the video chat application program may be configured to present, in a graphical user interface 110 displayed by a display device 112 of the computing system 100, a catalogue of different manually-generated avatars having different visual traits, such as different facial features, hair styles, skin colors, and accessories, among other traits. The user 106 may select a manually-generated avatar 218 from the catalogue and/or customize the manually-generated avatar 218 as desired to represent the user 106 in the video chat application program. The manually-generated avatar 218 comprises at least a first head 300 connected to a body 302 (shown in FIG. 3). In the illustrated example, the manually-generated avatar 218 comprises various assets 308, such as clothes on the body 302 as well as glasses and a hair style on the first head 300. In some examples, the manually-generated avatar 218 may comprise assets in the form of textures, such as skin or other features. Note that the manually-generated avatar 218 need not reflect the actual likeness of the user 106. Rather, the manually-generated avatar 218 has visual characteristics that the user 106 desires to be represented by in the digital environment.

The computing system 100 is configured to execute an avatar machine-learning model 224 (shown in FIG. 2). The avatar machine-learning model 224 is trained on training data including a plurality of three-dimensional scans of human heads. The three-dimensional scans of human heads can be obtained for a plurality of different human subjects that assume different head positions and facial expressions in order to have training data that covers a general population of user. The avatar machine-learning model 224 is configured to receive image data of the user captured by the camera 102 and audio data of the user captured by the microphone 104 and output a machine-generated avatar 226 (shown in FIG. 2) of the user 106 based at least on the image data and the audio data. The machine-generated avatar 226 of the user 106 comprises a second head 310 (shown in FIG. 3) having facial features that map to actual facial features of the user 106. Further, the second head 310 of the machine-generated avatar 226 can be animated to mimic actual movements of the user 106. More particularly, the mouth of the second head 310 of the machine-generated avatar 226 can be shaped to mimic the mouth of the user 106 when the user is speaking as detected from the audio data captured by the microphone 104. Similarly, the head pose and expressions of the second head 310 of the machine-generated avatar 226 can be mimicked based at least on video data of the user captured by the camera 102.

The computing system 100 is configured to generate a composite avatar 108 of the user 106 by replacing the first head 300 of the manually-generated avatar 218 with the second head 310 of the machine-generated avatar 226 on the body 302 of the manually-generated avatar 218. The computing system 100 is configured to display a graphical user interface 110 including the composite avatar 108 of the user 106 via a display device 112 of the computing system 100. For example, the graphical user interface 110 can be generated by the video chat application program. The composite avatar 108 of the user 106 has visual traits that accurately represent an identity of the user 106.

In the illustrated example, the composite avatar 108 of the user 106 further comprises assets 304 that are taken from the manually-generated avatar 218 including clothing, glasses, a hair style, skin texture (and/or other textures). In particular, the computing system 100 is configured to deform the glasses and the hair style that were generated for the first head 300 of the manually-generated avatar 218 to fit the second head 310 of the machine-generated avatar 226 on the composite avatar 108 of the user 106.

The computing system 100 is configured to animate the composite avatar 108 of the user 106 to mimic the head/body pose of the user 106 and the actual facial expressions emoted by the user 106 as the user 106 is interacting with the remote user via the video chat application program.

The computing system 100 is configured to display the composite avatar 108 of the user in the graphical user interface 110 via the display device. For example, the composite avatar 108 of the user 106 may be displayed to provide visual feedback to the user 106 of their identity, expressions, and movement represented by the composite avatar 108. The computing system 100 is further configured to display a composite avatar 114 representing the remote user in the graphical user interface 110. The composite avatar 114 of the remote user is generated by a remote computing system of the remote user. The composite avatar 114 is generated by the remote computing system using the same approach as the computing system 100 to generate the composite avatar 108 of the user 106. In one example, the remote computing system is configured to generate a video stream comprising the composite avatar 114 of the remote user and send, via a computer network, the video stream to the computing system 100 for display by the display device 112.

In the illustrated example, the composite avatars 108 and 110 are generated in the context of a video chat application program. It will be appreciated that the approach for generating a composite avatar discussed herein may be broadly applicable to numerous other digital environments, such as video games, online forums, virtual worlds, social media platforms, virtual reality and augmented reality environments.

FIG. 2 schematically shows a computer architecture diagram of an example computing system 200 of the present disclosure. For example, the computing system 200 may represent the computing system 100 of FIG. 1 or another suitable computing system. The computing system 200 comprises a logic subsystem 202 and a storage subsystem 204 holding instructions executable by the logic subsystem 202 to execute computing operations to control a state of the computing system 200. More particularly, the storage subsystem 204 holds instructions executable by the logic subsystem 202 to generate a composite avatar of a user that accurately represents an identity of the user and expressions emoted by the user.

The computing system 200 comprises a camera 206 that is configured to capture image data 208 of the user. The camera 206 may take any suitable form. For example, the camera may comprise a monochrome camera or a color (e.g., RGB) camera. In some implementations, the computing system 200 may further comprise one or more additional cameras including, but not limited, a depth camera, a thermal camera, an infrared camera, and/or another type of camera. In some implementations, the camera 102 is configured to capture a sequence of image frames of the user and the image data 208 comprises video data 210 that tracks movement of the user. In some implementations, the storage subsystem 202 holds instructions executable by the logic subsystem 204 to extract environmental lighting data 212 from the image data 208. The environmental light data 212 characterizes ambient lighting conditions in the environment of the user. The image data 208 including the video data 210 and the environmental lighting data 212, when applicable, may be used to generate a composite avatar 236 of the user according to the approach described herein.

The computing system 200 comprises a microphone 214 that is configured to capture audio data 216 representing speech of the user. The audio data 216 may be used to detect when the user is speaking. For example, the user may speak when interacting with other users in a digital environment, such as a video game, video chat application program, a social media platform, or a virtual reality/augmented reality environment. In some implementations, the audio data 216 may be used to generate the composite avatar 236 of the user according to the approach described herein.

The storage subsystem 202 holds instructions executable by the logic subsystem 204 to receive a manually-generated avatar 218. In some implementations, the manually-generated avatar 218 is generated by a skilled artist or team of artists (e.g., graphic designers) that designs different avatars for a particular computer application program or digital environment. In some implementations, the manually-generated avatar 218 is generated by a skilled artist or team of artists on a remote computing system 220 and sent to the computing system 200 via a computer network 222. In some implementations, the manually-generated avatar 218 may be a default avatar or a generic avatar that does not actually resemble the physical likeness of the user.

In other implementations, the manually-generated avatar is generated locally on the computing system 200. Returning to the example scenario shown in FIG. 1, the video chat application program may be configured to display a catalogue of different default manually-generated avatars having different visual traits, such as different facial features, hair styles, skin colors, and accessories, among other traits in the graphical user interface 110. The user 106 may select the manually-generated avatar 218 from the catalogue and/or customize the manually-generated avatar 218 as desired to represent the user 106 in the video chat application program. The user may customize the appearance of the manually-generated avatar 218 in any suitable manner. However, the manually-generated avatar 218 may lack actual head and facial features that match those of the user.

As shown in FIG. 3, the manually-generated avatar 218 comprises a first head 300 connected to a body 302. The manually-generated avatar 218 further comprises a plurality of assets 304. Example assets may comprise clothing, a hair style, facial hair, glasses, jewelry, a hat, other accessories, and textures (e.g., a skin texture).

In some implementations, the manually-generated avatar 218 is defined in terms of a first framework of parameters 306 in a first parameter space. In one example, the first framework of parameters 306 comprise a plurality of hand designed control parameters that map to different vertices of a three-dimensional model that defines the first head 300, body 302, and assets 304 of the manually-generated avatar 218. In one example, parameters of the first framework of parameters 306 for controlling the shape of the first head 300 comprise parameters such as parameters such as parameters such as jaw width, chin shape, chin height, cleft chin, cheek width, cheek height, cheek depth, head width, head length, head depth, among other parameters. When a skilled artist (or the user) is generating the manually-generated avatar 218, the different control parameters of the first framework of parameters 306 may use a sliding scale of parameters values for each parameter to modify the shape/features of the first head 302, the body 304, and the assets 304 of the manually-generated avatar 218. Different parameter values selected via the sliding scale may adjust the position of different vertices of the model to adjust the shape/features of the manually-generated avatar 218. In other implementations, the manually-generated avatar 218 may be defined by a different framework of parameters in a different parameter space.

In some implementations, the body 302 of the manually-generated avatar 218 may be configured to perform pre-programmed movements 308 based at least on parameter values of parameters 306 in the first parameter space. The manually-generated avatar 218 may be animated to perform the pre-programmed movements 308 via a sequence of changes to the parameter values that change the position of the appropriate vertices of the model that defines the manually-generated avatar 218. For example, the manually-generated avatar 218 may be animated to raise their hand, wave at someone, perform a dance routine, or perform some other type of movement that is relevant to the application in which the manually-generated avatar 218 is employed.

Returning to FIG. 2, the storage subsystem 202 holds instructions executable by the logic subsystem 204 to execute an avatar machine-learning model 224. The avatar machine-learning model 224 is trained on training data that comprises a plurality of three-dimensional scans of human heads. The three-dimensional scans of human heads can be obtained for a plurality of different human subjects that assume different head positions and facial expressions in order to have training data that covers a general population of user that emote numerous different expressions. The avatar machine-learning model 224 is configured to generate a machine-generated avatar 226 of the user based at least on the image data 208 of the user captured by the camera 206.

As shown in FIG. 3, the machine-generated avatar 226 comprises a second head 310. For example, the second head 310 lacks hair (because the hair is classified as an asset) and has facial features that map to actual facial features of the user as identified from the image data 208. Further, the size and shape of the second head 310 may map to the actual size and shape of the head of the user.

In some implementations, the machine-generated avatar 226 is defined in terms of a second framework of parameters 312 in a second parameter space. In one example, the second framework of parameters 312 comprise blendshapes. Blendshapes refer to a dictionary of named coefficients representing the detected facial expression of the user defined in terms of the movement of specific facial features. The corresponding value for each blendshape is a floating-point number indicating the current position of that feature relative to its neutral configuration, ranging for example from 0.0 (neutral) to 1.0 (maximum movement). Blendshape coefficients can be used to control animation of the second head 310 in ways that track the actual facial expressions of the user. In one example, the dictionary of blendshapes comprises ˜200 control parameters that are machine-learned by the avatar machine-learning model 224 based at least on a plurality of three-dimensional scans of human heads (e.g., ˜500 different human heads assuming different facial expressions).

In other implementations, the machine-generated avatar 226 may be defined by a different framework of parameters in a different parameter space.

Returning to FIG. 2, in some implementations, the storage subsystem 202 holds instructions executable by the logic subsystem 204 to execute a video-translation machine-learning model 228 that is configured to translate the video data 210 representing the movement of the user into corresponding parameter values of parameters 230 in the second parameter space. In some implementations, the video-translation machine-learning model 228 is trained based at least on training data including video data that is labeled with corresponding blendshapes. The parameter values of the parameters 230 in the second parameter space (e.g., blendshapes) may be fed as input to the avatar machine-learning model 224 to be used to generate the machine-generated avatar 226.

In some implementations, the storage subsystem 202 holds instructions executable by the logic subsystem 204 to execute an audio-translation machine-learning model 232 that is configured to translate the audio data 216 representing speech of the user into corresponding parameter values of parameters 230 in the second parameter space. In some implementations, the audio-translation machine-learning model 228 is trained based at least on training data including audio data of particular speech patterns and image data corresponding to images of faces of human subjects while speaking the particular speech patterns. The image data is labeled with corresponding blendshapes. The parameter values of the parameters 230 in the second parameter space (e.g., blendshapes) may be fed as input to the avatar machine-learning model 224 to be used to generate the machine-generated avatar 226.

The storage subsystem 202 holds instructions executable by the logic subsystem 204 to execute a composite avatar generation module 234 that is configured to generate a composite avatar 236 of the user by replacing the first head 300 of the manually-generated avatar 218 with the second head 310 of the machine-generated avatar 226 on the body 302 of the manually-generated avatar 218.

In implementations where the manually-generated avatar 218 comprises a plurality of assets 304 defining visual features on the first head 300, the composite avatar generation module 234 is configured to deform each asset of the plurality of assets 304 based at least on the parameter values of the parameters 312 in the second parameter space that define the second head 310 of the machine-generated avatar to fit the asset to the second head 310 of the machine-generated avatar 226. Further, the composite avatar generation module 234 is configured to attach the plurality of deformed assets 304 to the second head 310 of the composite avatar 236.

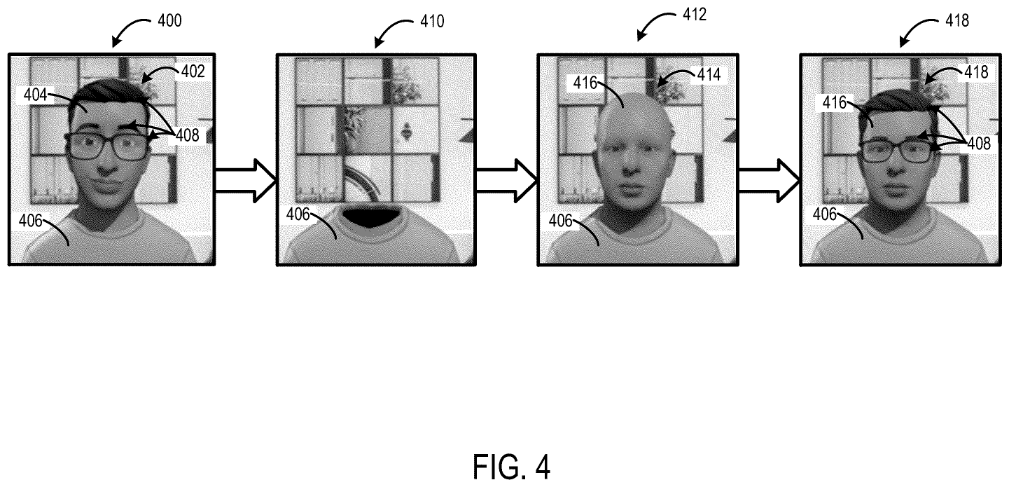

FIG. 4 shows an example process of generating an example composite avatar from a manually-generated avatar and a machine-generated avatar. At 400, a manually-generated avatar 402 is generated. For example, the manually-generated avatar 402 may correspond to the manually-generated avatar 218 shown in FIGS. 2-3. The manually-generated avatar 402 comprises a first head 404 connected to a body 406, and a plurality of assets 408 attached to the first head 404. In the illustrated example, the plurality of assets 408 comprise eyeglasses, eyebrows, a hairstyle, clothing on the body of the manually-generated avatar 402, and textures (e.g., a skin texture). The manually-generated avatar 402 is defined in terms of a first framework of parameters in a first parameter space, such as labeled vertices associated with different body parts and facial features.

At 410, the first head 404 of manually-generated avatar 402 is identified and removed from the body 406 of the manually-generated avatar 402. For example, vertices of the model that form the first head 404 may be labeled as such and differentiated from other parts of the body 406 of the manually-generated avatar 402. The vertices labeled as being part of the first head 404 may be removed. Further, the plurality of assets 408 may be removed from the first head 404 and retained for use in generating the composite avatar.

At 412, a machine-generated avatar 414 comprising a second head 416 is generated. For example, the machine-generated avatar 414 may correspond to the machine-generated avatar 226 shown in FIGS. 2-3. The second head 416 has facial features that map to actual facial features of the user. The second head 416 of the machine-generated avatar 414 is attached to the body 406 of the manually-generated avatar 402. In one example, this can be performed by creating a lattice warping from the vertices of the body 406 of manually-generated avatar 402 to vertices of the second head 416 of the machine-generated avatar 414 using per-vertex deltas to stich the second head 416 to the body 406. In some examples, the composite avatar 418 may be repeatedly generated in synchronization with a designated frame rate (e.g., of the display device, or the application program for which the composite avatar 418 is being generated). In other examples, the composite avatar 418 may be repeatedly generated at a rate that differs from the designated frame rate, such as once every 5 frames or ten frames. In still other examples, the second head 416 can be attached to the body 406 of the composite avatar 418 using a different approach.

Note that the second head 416 lacks assets (e.g., eyeglasses, eyebrows, a hairstyle). Accordingly, at 418, the plurality of assets 408 of the manually-generated avatar 402 are deformed to fit the second head 414 to generate a composite avatar 418. In one example, an asset can be deformed to fit the second head 416 by, for each vertex of the asset, find a nearest K vertices on the second head 416 to the position of the asset and map blendshape deltas of those K vertices to the vertex of the asset. The mapped blendshapes can be driven to deform the asset to fit the second head 416. In other examples, the plurality of assets 408 can be fit to the second head 416 of the composite avatar 418 using a different approach.

The composite avatar 418 leverages the assets from the manually-generated avatar 402 while having a head that more accurately represents the actual facial features of the user and can be animated to accurately represent actual expressions emoted by the user.

Returning to FIG. 2, the storage subsystem 202 holds instructions executable by the logic subsystem 204 to display the composite avatar 236 in a graphical user interface 238 via a display device 240 of the computing system 200. The graphical user interface 238 may be incorporated into any suitable computer application program where the composite avatar 236 is used in a digital environment, such as a video game, video chat application program, a social media platform, or a virtual reality/augmented reality environment.

In some implementations, the storage subsystem 202 holds instructions executable by the logic subsystem 204 to animate the composite avatar 236 to demonstrate various movements and emote various expressions. In some implementations, the second head 310 of the composite avatar 236 can be controlled by adjusting blendshapes for the second head 310 and the body 302 of the composite avatar 236 can be used to adjust the positions of appropriate vertices of the body 302. In such implementations, the composite avatar 236 is controlled using two sets of control parameters in different parameter spaces. In other implementations, the controls for the second head 310 can be mapped to parameter values of the parameters in the first parameter space, such that the second head 310 and the body 302 can be controlled using parameter values in the first parameter space. In yet other implementations, the controls for the body 302 can be mapped to parameter values of the parameters in the second parameter space, such that the second head 310 and the body 302 can be controlled using parameter values in the second parameter space.

In some implementations, the storage subsystem 202 holds instructions executable by the logic subsystem 204 to animate the second head 310 of the composite avatar 236 to mimic a head pose of the user and an expression of the user based at least on the parameter values of the parameters 230 in the second parameter space output by the video-translation machine-learning model 228 based at least on the video data 210. This can be referred to as camera-based face tracking.

In some implementations, the storage subsystem 202 holds instructions executable by the logic subsystem 204 to animate the second head 310 of the composite avatar 236 to mimic an expression of the user to produce the speech of the user based at least on the parameter values 230 of the parameters in the second parameter space output by the audio-translation machine-learning model 232 based at least on the audio data 216. This can be referred to as microphone-based face tracking. The camera-based face tracking and microphone-based face tracking can be leveraged to automatically animate the composite avatar 236 to track actual movements and expressions performed by the user.

In some implementations, the storage subsystem 202 holds instructions executable by the logic subsystem 204 to animate the body 302 of the composite avatar 236 to perform a pre-programmed movement 308 based at least on parameter values of parameters 306 in the first parameter space. The pre-programmed movement 308 need not track actual movements of the user and may provide other gestures that are useful for various applications. For example, such pre-programmed animations may comprise raising a hand, clapping, dancing, or other movements that can communicate information on behalf of the user in the digital environment.

In some implementations, the storage subsystem 202 holds instructions executable by the logic subsystem 204 to animate the second head 310 of the composite avatar 236 to mimic an expression of the user and move and/or deform the plurality assets 308 based at least on the animation of the second head 310 to mimic the expression of the user. When the second head moves or changes to track the actual movement or expressions of the user, the plurality of assets 308 are deformed and/or moved accordingly to stay synchronized with the composite avatar 236 and maintain an accurate representation of the user.

In some implementations, the storage subsystem 202 holds instructions executable by the logic subsystem 204 to shade the composite avatar 236 based at least on the environmental lighting data 212 extracted from the image data 208 of the user. The environmental lighting data 212 characterizes the ambient lighting conditions in the surrounding environment of the user. The environmental lighting data 212 can be used to shade physical features the composite avatar 236, such as the skin, lips, hair, eyes. In some examples, the composite avatar 236 may have a neutral base skin texture color and different baked lighting/shadows can be applied to the composite avatar 236 based at least on the environmental lighting data 212. In the context of rendering textures, “baked” refers to a process where certain characteristics or properties of a texture, such as lighting information, shadows, or ambient occlusion, are pre-calculated and stored into the texture itself. “Baking” textures helps to improve rendering performance by reducing the amount of real-time calculations needed during rendering. For example, instead of calculating complex lighting effects for each frame in real-time, the lighting information can be baked into the texture beforehand, resulting in faster rendering with less computational overhead.

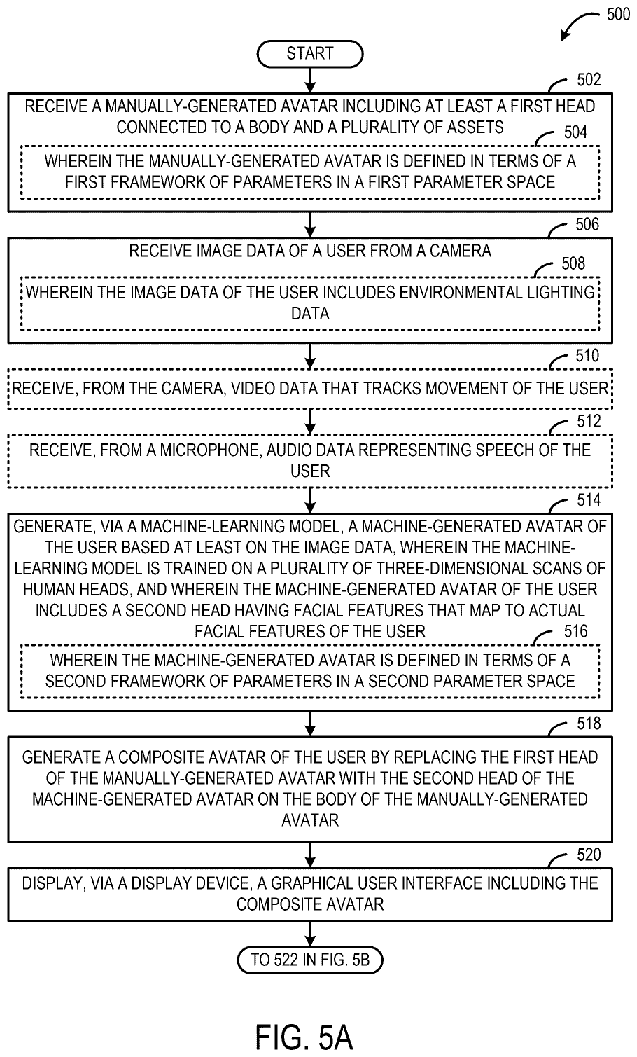

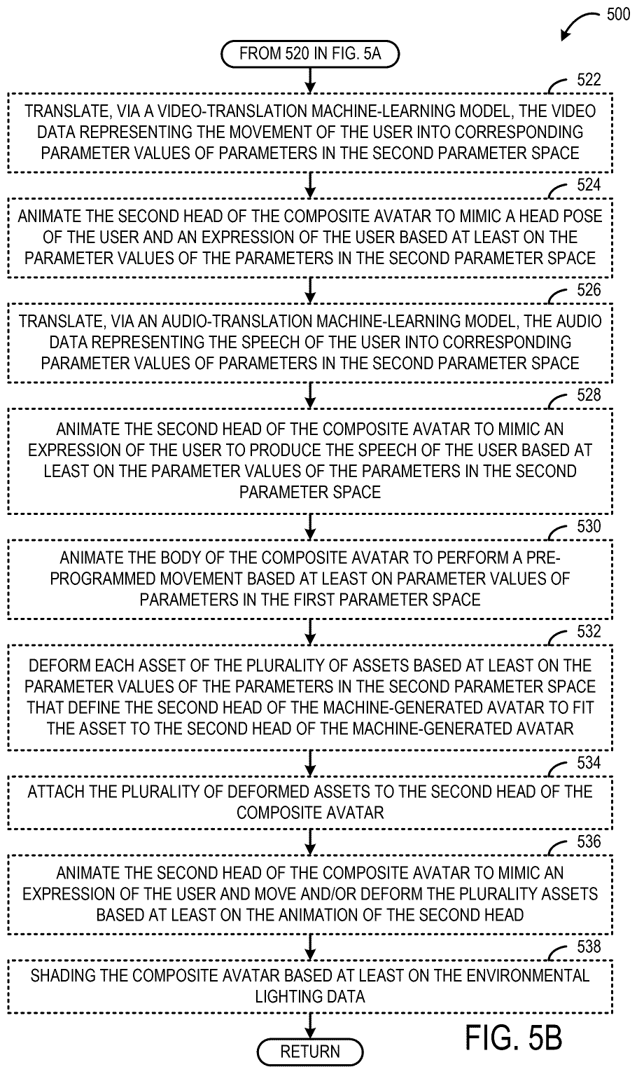

FIGS. 5A-5B show an example method 500 of generating a composite avatar. The method 500 may be performed by a computing system, such as the computing system 100 shown in FIG. 1, the computing system 200 shown in FIG. 2, or another suitable computing system. Note that method steps indicated in dotted lines may be optional in some implementations.

In FIG. 5A, at 502, the method 500 comprises receiving a manually-generated avatar including at least a first head connected to a body and a plurality of assets. For example, the plurality of assets may comprise eyeglasses, eyebrows, a hairstyle, facial hair, a hat, jewelry, other accessories clothing, and textures (e.g., a skin texture). In some implementations, at 504, the manually-generated avatar is defined in terms of a first framework of parameters in a first parameter space. For example, the first framework of parameters may comprise a plurality of hand designed control parameters that map to different vertices of a three-dimensional model that defines the manually-generated avatar.

At 506, the method 500 includes receiving image data of a user from a camera. In some implementations, at 508, the image data may comprise environmental lighting data that characterizes ambient lighting conditions in the surrounding environment of the user.

In some implementations, at 510, the method 500 may comprise receiving, from the camera, video data that tracks movement of the user. Additionally, in some implementations, at 512, the method 500 may comprise receiving, from a microphone, audio data representing speech of the user.

At 514, the method 500 includes generating, via an avatar machine-learning model, a machine-generated avatar of the user based at least on the image data. The avatar machine-learning model is trained on training data including a plurality of three-dimensional scans of human heads. The machine-generated avatar of the user comprises a second head having facial features that map to actual facial features of the user. In some implementations, at 516, the machine-generated avatar may be defined in terms of a second framework of parameters in a second parameter space. For example, the second framework of parameters may comprise blendshapes. Blendshapes refer to a dictionary of named coefficients representing the detected facial expression of the user defined in terms of the movement of specific facial features.

At 518, the method 500 includes generating a composite avatar of the user by replacing the first head of the manually-generated avatar with the second head of the machine-generated avatar on the body of the manually-generated avatar. At 520, the method 500 includes displaying, via a display device, a graphical user interface including the composite avatar.

In FIG. 5B, in some implementations, at 522, the method 500 may comprise translating, via a video-translation machine-learning model, the video data representing the movement of the user into corresponding parameter values of parameters in the second parameter space. At 524, the method may comprise animating the second head of the composite avatar to mimic a head pose of the user and an expression of the user based at least on the parameter values of the parameters in the second parameter space output by the video-translation machine-learning model.

In some implementations, at 526, the method 500 may comprise translating, via an audio-translation machine-learning model, the audio data representing the speech of the user into corresponding parameter values of parameters in the second parameter space. At 528, the method 500 may comprise animating the second head of the composite avatar to mimic an expression of the user to produce the speech of the user based at least on the parameter values of the parameters in the second parameter space output by the audio-translation machine-learning model.

In some implementations, at 530, the method 500 may comprise animating the body of the composite avatar to perform a pre-programmed movement based at least on parameter values of parameters in the first parameter space.

In some implementations, at 532, the method 500 may comprise deforming each asset of the plurality of assets based at least on the parameter values of the parameters in the second parameter space that define the second head of the machine-generated avatar to fit the asset to the second head of the machine-generated avatar. At 534, the method 500 may comprise attaching the plurality of deformed assets to the second head of the composite avatar.

In some implementations, at 536, the method 500 may comprise animating the second head of the composite avatar to mimic an expression of the user and moving and/or deforming the plurality assets based at least on the animation of the second head to mimic the expression of the user.

In some implementations, at 536, the method 500 may comprise shading the composite avatar based at least on the environmental lighting data.

The method 500 may be performed to generate a composite avatar from a combination of a manually-generated avatar and a machine-generated avatar. More particularly, by replacing the first head of the manually-generated avatar with the second head of the machine-generated avatar in the composite avatar provides the technical benefit of the composite avatar having facial features that more accurately represent the identity of the user and expressions emoted by user than the manually-generated avatar alone. Moreover, since the second head of the composite avatar is generated by a machine learning model, the time and manual work expended by a human to generate the composite avatar may be less than an equivalent version of the avatar generated solely by humans. Moreover, in some implementations, the assets created for the first head of the manually-generated avatar can be deformed to fit the second head of the machine-generated avatar, so that the composite avatar can be customized as desired by the user while still preserving accurate identity and emotions of the user.

The methods and processes described herein may be tied to a computing system of one or more computing devices. In particular, such methods and processes may be implemented as an executable computer-application program, a network-accessible computing service, an application-programming interface (API), a library, or a combination of the above and/or other compute resources.

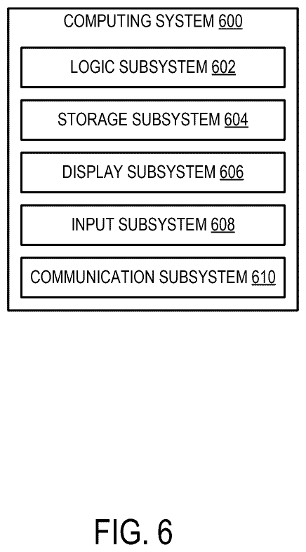

FIG. 6 schematically shows a simplified representation of a computing system 600 configured to provide any to all of the compute functionality described herein. For example, the computing system 600 may correspond to the computing system 100 shown in FIG. 1 and the computing system 200 shown in FIG. 2. Computing system 600 may take the form of one or more personal computers, network-accessible server computers, tablet computers, home-entertainment computers, gaming devices, mobile computing devices, mobile communication devices (e.g., smart phone), virtual/augmented/mixed reality computing devices, wearable computing devices, Internet of Things (IoT) devices, embedded computing devices, and/or other computing devices.

Computing system 600 comprises a logic subsystem 602 and a storage subsystem 604. Computing system 600 may optionally comprise a display subsystem 606, input subsystem 608, communication subsystem 610, and/or other subsystems not shown in FIG. 6.

Logic subsystem 602 comprises one or more physical devices configured to execute instructions. For example, the logic subsystem may be configured to execute instructions that are part of one or more applications, services, or other logical constructs. The logic subsystem may comprise one or more hardware processors configured to execute software instructions. Additionally, or alternatively, the logic subsystem may comprise one or more hardware or firmware devices configured to execute hardware or firmware instructions. Processors of the logic subsystem may be single-core or multi-core, and the instructions executed thereon may be configured for sequential, parallel, and/or distributed processing. Individual components of the logic subsystem may optionally be distributed among two or more separate devices, which may be remotely located and/or configured for coordinated processing. Aspects of the logic subsystem may be virtualized and executed by remotely-accessible, networked computing devices configured in a cloud-computing configuration.

Storage subsystem 604 comprises one or more physical devices configured to temporarily and/or permanently hold computer information such as data and instructions executable by the logic subsystem. When the storage subsystem comprises two or more devices, the devices may be collocated and/or remotely located. Storage subsystem 604 may comprise volatile, nonvolatile, dynamic, static, read/write, read-only, random-access, sequential-access, location-addressable, file-addressable, and/or content-addressable devices. Storage subsystem 604 may comprise removable and/or built-in devices. When the logic subsystem executes instructions, the state of storage subsystem 604 may be transformed—e.g., to hold different data.

Aspects of logic subsystem 602 and storage subsystem 604 may be integrated together into one or more hardware-logic components. Such hardware-logic components may comprise program- and application-specific integrated circuits (PASIC/ASICs), program-and application-specific standard products (PSSP/ASSPs), system-on-a-chip (SOC), and complex programmable logic devices (CPLDs), for example.

The logic subsystem and the storage subsystem may cooperate to instantiate one or more logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine may be instantiated by a single computing device, or a machine may comprise two or more sub-components instantiated by two or more different computing devices. In some implementations a machine comprises a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

The term “module” may be used to describe an aspect of computing system 600 implemented to perform a particular function. In some cases, a module may be instantiated via logic machine 602 executing instructions held by storage subsystem 604. It will be understood that different modules may be instantiated from the same application, service, code block, object, library, routine, API, function, etc. Likewise, the same module may be instantiated by different applications, services, code blocks, objects, routines, APIs, functions, etc. The term “module” may encompass individual or groups of executable files, data files, libraries, drivers, scripts, database records, etc.

Machines may be implemented using any suitable combination of state-of-the-art and/or future machine learning (ML), artificial intelligence (AI), and/or natural language processing (NLP) techniques. Non-limiting examples of techniques that may be incorporated in an implementation of one or more machines comprise support vector machines, multi-layer neural networks, convolutional neural networks (e.g., including spatial convolutional networks for processing images and/or videos, temporal convolutional neural networks for processing audio signals and/or natural language sentences, and/or any other suitable convolutional neural networks configured to convolve and pool features across one or more temporal and/or spatial dimensions), recurrent neural networks (e.g., long short-term memory networks), associative memories (e.g., lookup tables, hash tables, Bloom Filters, Neural Turing Machine and/or Neural Random Access Memory), word embedding models (e.g., GloVe or Word2Vec), unsupervised spatial and/or clustering methods (e.g., nearest neighbor algorithms, topological data analysis, and/or k-means clustering), graphical models (e.g., (hidden) Markov models, Markov random fields, (hidden) conditional random fields, and/or AI knowledge bases), and/or natural language processing techniques (e.g., tokenization, stemming, constituency and/or dependency parsing, and/or intent recognition, segmental models, and/or super-segmental models (e.g., hidden dynamic models)).

In some examples, the methods and processes described herein may be implemented using one or more differentiable functions, wherein a gradient of the differentiable functions may be calculated and/or estimated with regard to inputs and/or outputs of the differentiable functions (e.g., with regard to training data, and/or with regard to an objective function). Such methods and processes may be at least partially determined by a set of trainable parameters. Accordingly, the trainable parameters for a particular method or process may be adjusted through any suitable training procedure, in order to continually improve functioning of the method or process.

Non-limiting examples of training procedures for adjusting trainable parameters comprise supervised training (e.g., using gradient descent or any other suitable optimization method), zero-shot, few-shot, unsupervised learning methods (e.g., classification based on classes derived from unsupervised clustering methods), reinforcement learning (e.g., deep Q learning based on feedback) and/or generative adversarial neural network training methods, belief propagation, RANSAC (random sample consensus), contextual bandit methods, maximum likelihood methods, and/or expectation maximization. In some examples, a plurality of methods, processes, and/or components of systems described herein may be trained simultaneously with regard to an objective function measuring performance of collective functioning of the plurality of components (e.g., with regard to reinforcement feedback and/or with regard to labelled training data). Simultaneously training the plurality of methods, processes, and/or components may improve such collective functioning. In some examples, one or more methods, processes, and/or components may be trained independently of other components (e.g., offline training on historical data).

When included, display subsystem 606 may be used to present a visual representation of data held by storage subsystem 604. This visual representation may take the form of a graphical user interface (GUI). Display subsystem 606 may comprise one or more display devices utilizing virtually any type of technology. In some implementations, display subsystem may comprise one or more virtual-, augmented-, or mixed reality displays.

When included, input subsystem 608 may comprise or interface with one or more input devices. An input device may comprise a sensor device or a user input device. Examples of user input devices comprise a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on-or off-board. Example NUI componentry may comprise a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, communication subsystem 610 may be configured to communicatively couple computing system 600 with one or more other computing devices. Communication subsystem 610 may comprise wired and/or wireless communication devices compatible with one or more different communication protocols. The communication subsystem may be configured for communication via personal-, local- and/or wide-area networks.

In an example, a method performed by a computing system comprises receiving a manually-generated avatar including at least a first head connected to a body, receiving image data of a user from a camera, generating, via an avatar machine-learning model, a machine-generated avatar of the user based at least on the image data, wherein the avatar machine-learning model is trained on training data including a plurality of three-dimensional scans of human heads, and wherein the machine-generated avatar of the user comprises a second head having facial features that map to actual facial features of the user, generating a composite avatar of the user by replacing the first head of the manually-generated avatar with the second head of the machine-generated avatar on the body of the manually-generated avatar, and displaying, via a display device, a graphical user interface including the composite avatar. In this example and/or other examples, the manually-generated avatar may be defined in terms of a first framework of parameters in a first parameter space, and the machine-generated avatar may be defined in terms of a second framework of parameters in a second parameter space. In this example and/or other examples, the method may further comprise receiving video data that tracks movement of the user from the camera, translating, via a video-translation machine-learning model, the video data representing the movement of the user into corresponding parameter values of parameters in the second parameter space, and animating the second head of the composite avatar to mimic a head pose of the user and an expression of the user based at least on the parameter values of the parameters in the second parameter space output by the video-translation machine-learning model. In this example and/or other examples, the method may further comprise receiving audio data representing speech of the user from a microphone, translating, via an audio-translation machine-learning model, the audio data representing the speech of the user into corresponding parameter values of parameters in the second parameter space, and animating the second head of the composite avatar to mimic an expression of the user to produce the speech of the user based at least on the parameter values of the parameters in the second parameter space output by the audio-translation machine-learning model. In this example and/or other examples, the method may further comprise animating the body of the composite avatar to perform a pre-programmed movement based at least on parameter values of parameters in the first parameter space. In this example and/or other examples, the manually-generated avatar may comprise a plurality of assets defining visual features on the first head, and the method may further comprise deforming each asset of the plurality of assets based at least on the parameter values of the parameters in the second parameter space that define the second head of the machine-generated avatar to fit the asset to the second head of the machine-generated avatar, and attaching the plurality of deformed assets to the second head of the composite avatar. In this example and/or other examples, the method may further comprise animating the second head of the composite avatar to mimic an expression of the user and moving and/or deforming the plurality assets based at least on the animation of the second head to mimic the expression of the user. In this example and/or other examples, the image data of the user may comprise environmental lighting data, and the method may further comprise shading the composite avatar based at least on the environmental lighting data.

In another example, a computing system, comprises a display device, a logic subsystem, and a storage subsystem holding instructions executable by the logic subsystem to receive a manually-generated avatar including at least a first head connected to a body, receive image data of a user from a camera, generate, via an avatar machine-learning model, a machine-generated avatar of the user based at least on the image data, wherein the avatar machine-learning model is trained on training data including a plurality of three-dimensional scans of human heads, and wherein the machine-generated avatar of the user comprises a second head having facial features that map to actual facial features of the user, generate a composite avatar of the user by replacing the first head of the manually-generated avatar with the second head of the machine-generated avatar on the body of the manually-generated avatar, and display, via the display device, a graphical user interface including the composite avatar. In this example and/or other examples, the manually-generated avatar may be defined in terms of a first framework of parameters in a first parameter space, and the machine-generated avatar may be defined in terms of a second framework of parameters in a second parameter space. In this example and/or other examples, the storage subsystem may hold instructions executable by the logic subsystem to receive video data that tracks movement of the user from the camera, translate, via a video-translation machine-learning model, the video data representing the movement of the user into corresponding parameter values of parameters in the second parameter space, and animate the second head of the composite avatar to mimic a head pose of the user and an expression of the user based at least on the parameter values of the parameters in the second parameter space output by the video-translation machine-learning model. In this example and/or other examples, the storage subsystem may hold instructions executable by the logic subsystem to receive audio data representing speech of the user from a microphone, translate, via an audio-translation machine-learning model, the audio data representing the speech of the user into corresponding parameter values of parameters in the second parameter space, and animate the second head of the composite avatar to mimic an expression of the user to produce the speech of the user based at least on the parameter values of the parameters in the second parameter space output by the audio-translation machine-learning model. In this example and/or other examples, the storage subsystem may hold instructions executable by the logic subsystem to animate the body of the composite avatar to perform a pre-programmed movement based at least on parameter values of parameters in the first parameter space. In this example and/or other examples, the manually-generated avatar may comprise a plurality of assets defining visual features on the first head, and the storage subsystem may hold instructions executable by the logic subsystem to deform each asset of the plurality of assets based at least on the parameter values of the parameters in the second parameter space that define the second head of the machine-generated avatar to fit the asset to the second head of the machine-generated avatar, and attach the plurality of deformed assets to the second head of the composite avatar. In this example and/or other examples, the storage subsystem may hold instructions executable by the logic subsystem to animate the second head of the composite avatar to mimic an expression of the user and move and/or deform the plurality assets based at least on the animation of the second head to mimic the expression of the user. In this example and/or other examples, the image data of the user may comprise environmental lighting data, and the storage subsystem may hold instructions executable by the logic subsystem to shade the composite avatar based at least on the environmental lighting data.

In yet another example, a method performed by a computing system comprises receiving a manually-generated avatar including at least a first head connected to a body and a plurality of assets defining visual features on the first head, receiving image data of a user from a camera, generating, via an avatar machine-learning model, a machine-generated avatar of the user based at least on the image data, wherein the avatar machine-learning model is trained on training data including a plurality of three-dimensional scans of human heads, and wherein the machine-generated avatar of the user comprises a second head having facial features that map to actual facial features of the user, generating a composite avatar of the user by replacing the first head of the manually-generated avatar with the second head of the machine-generated avatar on the body of the manually-generated avatar, deforming each asset of the plurality of assets to fit the asset to the second head of the machine-generated avatar, attaching the plurality of deformed assets to the second head of the composite avatar, and displaying, via a display device, a graphical user interface including the composite avatar including the plurality of deformed assets attached to the second head. In this example and/or other examples, the plurality of assets may comprise at least one of a hair style, eyebrows, facial hair, eyeglasses, hats, and jewelry. In this example and/or other examples, the manually-generated avatar may be defined in terms of a first framework of parameters in a first parameter space, the machine-generated avatar may be defined in terms of a second framework of parameters in a second parameter space, and each of the plurality of assets may be deformed based at least on the parameter values of the parameters in the second parameter space that define the second head of the machine-generated avatar. In this example and/or other examples, the method may further comprise animating the second head of the composite avatar to mimic an expression of the user and moving and/or deforming the plurality assets based at least on the animation of the second head to mimic the expression of the user.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure comprises all novel and non-obvious combinations and sub-combinations of the various processes, systems and configurations, and other features, functions, acts, and/or properties disclosed herein, as well as any and all equivalents thereof.

1. A method performed by a computing system, the method comprising:
receiving a manually-generated avatar including at least a first head connected to a body;
receiving image data of a user from a camera;
generating, via an avatar machine-learning model, a machine-generated avatar of the user based at least on the image data, wherein the avatar machine-learning model is trained on training data including a plurality of three-dimensional scans of human heads, and wherein the machine-generated avatar of the user comprises a second head having facial features that map to actual facial features of the user;
generating a composite avatar of the user by replacing the first head of the manually-generated avatar with the second head of the machine-generated avatar on the body of the manually-generated avatar; and
displaying, via a display device, a graphical user interface including the composite avatar.

2. The method of claim 1, wherein the manually-generated avatar is defined in terms of a first framework of parameters in a first parameter space, and wherein the machine-generated avatar is defined in terms of a second framework of parameters in a second parameter space.

3. The method of claim 2, further comprising:
receiving video data that tracks movement of the user from the camera;
translating, via a video-translation machine-learning model, the video data representing the movement of the user into corresponding parameter values of parameters in the second parameter space; and
animating the second head of the composite avatar to mimic a head pose of the user and an expression of the user based at least on the parameter values of the parameters in the second parameter space output by the video-translation machine-learning model.

4. The method of claim 2, further comprising:
receiving audio data representing speech of the user from a microphone;
translating, via an audio-translation machine-learning model, the audio data representing the speech of the user into corresponding parameter values of parameters in the second parameter space; and
animating the second head of the composite avatar to mimic an expression of the user to produce the speech of the user based at least on the parameter values of the parameters in the second parameter space output by the audio-translation machine-learning model.

5. The method of claim 2, further comprising:
animating the body of the composite avatar to perform a pre-programmed movement based at least on parameter values of parameters in the first parameter space.

6. The method of claim 2, wherein the manually-generated avatar comprises a plurality of assets defining visual features on the first head, and wherein the method further comprises:
deforming each asset of the plurality of assets based at least on the parameter values of the parameters in the second parameter space that define the second head of the machine-generated avatar to fit the asset to the second head of the machine-generated avatar, and
attaching the plurality of deformed assets to the second head of the composite avatar.

7. The method of claim 6, further comprising:
animating the second head of the composite avatar to mimic an expression of the user and moving and/or deforming the plurality assets based at least on the animation of the second head to mimic the expression of the user.

8. The method of claim 1, wherein the image data of the user comprises environmental lighting data, and wherein the method further comprises:
shading the composite avatar based at least on the environmental lighting data.

9. A computing system, comprising:
a display device;
a logic subsystem; and
a storage subsystem holding instructions executable by the logic subsystem to:
receive a manually-generated avatar including at least a first head connected to a body;
receive image data of a user from a camera;
generate, via an avatar machine-learning model, a machine-generated avatar of the user based at least on the image data, wherein the avatar machine-learning model is trained on training data including a plurality of three-dimensional scans of human heads, and wherein the machine-generated avatar of the user comprises a second head having facial features that map to actual facial features of the user;
generate a composite avatar of the user by replacing the first head of the manually-generated avatar with the second head of the machine-generated avatar on the body of the manually-generated avatar; and
display, via the display device, a graphical user interface including the composite avatar.

10. The computing system of claim 9, wherein the manually-generated avatar is defined in terms of a first framework of parameters in a first parameter space, and wherein the machine-generated avatar is defined in terms of a second framework of parameters in a second parameter space.

11. The computing system of claim 10, wherein the storage subsystem holds instructions executable by the logic subsystem to:
receive video data that tracks movement of the user from the camera;
translate, via a video-translation machine-learning model, the video data representing the movement of the user into corresponding parameter values of parameters in the second parameter space; and
animate the second head of the composite avatar to mimic a head pose of the user and an expression of the user based at least on the parameter values of the parameters in the second parameter space output by the video-translation machine-learning model.

12. The computing system of claim 10, wherein the storage subsystem holds instructions executable by the logic subsystem to:
receive audio data representing speech of the user from a microphone;
translate, via an audio-translation machine-learning model, the audio data representing the speech of the user into corresponding parameter values of parameters in the second parameter space; and
animate the second head of the composite avatar to mimic an expression of the user to produce the speech of the user based at least on the parameter values of the parameters in the second parameter space output by the audio-translation machine-learning model.

13. The computing system of claim 10, wherein the storage subsystem holds instructions executable by the logic subsystem to:
animate the body of the composite avatar to perform a pre-programmed movement based at least on parameter values of parameters in the first parameter space.

14. The computing system of claim 10, wherein the manually-generated avatar comprises a plurality of assets defining visual features on the first head, and wherein the storage subsystem holds instructions executable by the logic subsystem to:
deform each asset of the plurality of assets based at least on the parameter values of the parameters in the second parameter space that define the second head of the machine-generated avatar to fit the asset to the second head of the machine-generated avatar, and
attach the plurality of deformed assets to the second head of the composite avatar.

15. The computing system of claim 14, wherein the storage subsystem holds instructions executable by the logic subsystem to:
animate the second head of the composite avatar to mimic an expression of the user and move and/or deform the plurality assets based at least on the animation of the second head to mimic the expression of the user.

16. The computing system of claim 9, wherein the image data of the user comprises environmental lighting data, and wherein the storage subsystem holds instructions executable by the logic subsystem to:
shade the composite avatar based at least on the environmental lighting data.

17. A method performed by a computing system, the method comprising:
receiving a manually-generated avatar including at least a first head connected to a body and a plurality of assets defining visual features on the first head;
receiving image data of a user from a camera;
generating, via an avatar machine-learning model, a machine-generated avatar of the user based at least on the image data, wherein the avatar machine-learning model is trained on training data including a plurality of three-dimensional scans of human heads, and wherein the machine-generated avatar of the user comprises a second head having facial features that map to actual facial features of the user;
generating a composite avatar of the user by replacing the first head of the manually-generated avatar with the second head of the machine-generated avatar on the body of the manually-generated avatar;
deforming each asset of the plurality of assets to fit the asset to the second head of the machine-generated avatar;
attaching the plurality of deformed assets to the second head of the composite avatar; and
displaying, via a display device, a graphical user interface including the composite avatar including the plurality of deformed assets attached to the second head.

18. The method of claim 17, wherein the plurality of assets comprises at least one of a hair style, eyebrows, facial hair, eyeglasses, hats, and jewelry.

19. The method of claim 17, wherein the manually-generated avatar is defined in terms of a first framework of parameters in a first parameter space, wherein the machine-generated avatar is defined in terms of a second framework of parameters in a second parameter space, and wherein each of the plurality of assets are deformed based at least on the parameter values of the parameters in the second parameter space that define the second head of the machine-generated avatar.

20. The method of claim 17, further comprising:
animating the second head of the composite avatar to mimic an expression of the user and moving and/or deforming the plurality assets based at least on the animation of the second head to mimic the expression of the user.
